(19) United States
(12) Patent Application Publication
(10) Pub. No.: US 2009/0241885 A1
(43) Pub. Date: Oct. 1, 2009

(54) Intake Device for an Internal Combustion Engine

(75) Inventor: Pedro Miguel Pereira Madeira, Bietigheim-Bissingen (DE)

Correspondence Address: Mann+Hummel GMBH, Dept: VR-P Plant 5.4, Hindenburgstr. 45, Ludwigsburg, 71638, DE

(73) Assignee: MANN+HUMMEL GMBH, Ludwigsburg (DE)

(21) Appl. No.: 12/373,353

(22) PCT Filed: Jul. 16, 2007
(86) PCT No.: PCT/EP2007/057314

§ 371 Date: Jan. 12, 2009

(30) Foreign Application Priority Data
Jul. 14, 2006 (DE) 20 2006 011027.5

(51) Int. Cl. F02M 35/10

(52) U.S. Cl. 123/184.21

(57) ABSTRACT

An intake device for an internal combustion engine includes two abutting parts 2 and 8, wherein a support pin 3 is disposed on the first plastic housing part 2, the support pin being guided through a corresponding opening 10 in the second housing part 8.

### TECHNICAL FIELD

The invention concerns an intake device for an internal combustion engine.

### BACKGROUND OF THE INVENTION

The invention concerns an intake device for an internal combustion engine. Such an intake device, disclosed in DE 199 44 855 A1, is comprised of a plurality of plastic housing parts connected to one another through which the taken-in combustion air flow is supplied to the cylinders of the internal combustion engine. The plastic housing parts define the intake passages for each cylinder. Each housing part comprises section-wise the walls of several intake passages that are to be combined with corresponding wall sections of a second housing part. In the mounted state the housing parts to be connected rest with welding surfaces that are enlarged in a flange-like fashion against one another and are connected to one another by friction welding. When mounting the intake device on the internal combustion engine care must be taken that the intake device's own weight and the dynamic forces occurring during operation will not damage the plastic part housing.

### SUMMARY OF THE INVENTION

The invention has the objects to configure an intake device for an internal combustion engine provided with at least two plastic housing parts that are resting against one another so as to have a high stability and operational safety.

This object is solved according to the invention with the features of claim 1. The dependent claims provide expedient further embodiments.

The intake device according to the invention has at least two plastic housing parts resting against one another wherein on the first plastic housing part a support pin is arranged that passes through a matching cutout in the second plastic housing part. This support pin is able to receive or dissipate additional supporting forces so that local loading can be distributed to several support locations so that the load acting on a support location is reduced. At the same time, a compact configuration is achieved because the support pin can be centrally arranged so that it is not required to position the support pin so as to laterally project which would lead to a greater outer contour. As a result of the central arrangement of the support pin on the plastic housing part a uniform force distribution into the walls of this housing part is achieved.

A further advantage of this embodiment resides in that the support by means of the support pin on the first plastic housing part can be configured independent of the second plastic housing part because the second housing part does not participate directly in the support action by means of the pin. Since, as a result of the cutout, the pin passes through the second housing part there are no supporting forces acting directly on the second housing part. This configuration makes it possible that either differently designed second housing parts can be used or, optionally, the second housing part can be eliminated entirely without this requiring constructional changes on the first housing part. The use of same parts achieved in this way aids in cost reduction.

According to an expedient embodiment it is provided that the support pin arranged on the first plastic housing part has a support projection that extends in particular along the connection of the pin to the wall of the housing part and in the mounted position rests on a corresponding support shoulder that delimits the cutout in the second plastic housing part. Support shoulder and support projection can serve as welding surfaces in order to connect by welding the two plastic housing parts with one another in this area, for example, by way of friction welding, so that the interior enclosed by the two plastic housing parts is closed off pressure-tightly in the area of the support pin. This embodiment is suitable in particular for use of the second housing part as a vacuum storage device. In this case, the two housing parts are expediently also connected with one another in a pressure-tight way along their circumference, in particular welded or friction-welded, in order to seal the interior of the vacuum storage device to all sides in a pressure-tight way.

The vacuum storage device has expediently two storage sections of different depth that are connected to one another fluidically wherein the cutout for the support pin is integrated into the shallower storage section. The deeper storage section has a greater volume; the shallower storage section enables the use of support pins of shorter configuration.

### BRIEF DESCRIPTION OF THE DRAWINGS

Further advantages and expedient embodiments can be taken from the further claims, the figure description, and the drawings.

FIG. 1 a perspective view from below onto an intake device for an internal combustion engine with a first plastic housing part embodied as an intake module in which the intake passages for supplying the combustion air to the cylinders are provided;

FIG. 2 an illustration corresponding to FIG. 1 but with an additional second plastic housing part that is embodied as a vacuum storage device and that is placed onto the first plastic housing part wherein a support pin on the first housing part projects through a cutout in the second housing part;

FIG. 3 the first and second housing parts in isolated illustration in a perspective view;

FIG. 4 the first housing part embodied as an intake module in individual illustration;

FIG. 5 the second housing part embodied as a vacuum storage device in individual illustration;

FIG. 6 a view of the interior of the vacuum storage device;

FIG. 7 a section view according to section line A-A of the device illustrated in FIG. 2;

FIG. 8 a section view according to section line A-A of the device illustrated in FIG. 2 in a further embodiment; and

FIG. 9 a section view according to section line A-A of the device illustrated in FIG. 2 in yet another embodiment.

In the Figures same parts are identified with same reference numerals.

### DESCRIPTION OF THE PREFERRED EMBODIMENTS

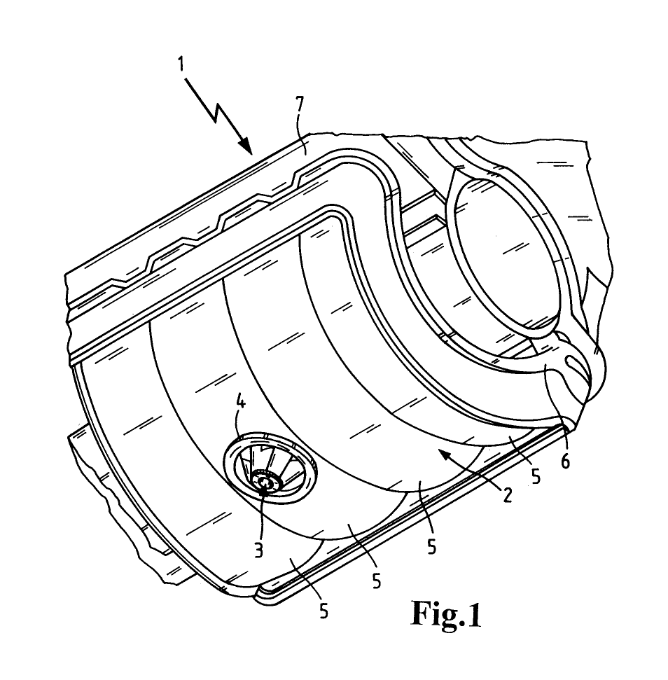

In FIG. 1 an air intake device 1 for an internal combustion engine is illustrated that is assembled of several plastic housing parts and in which air intake passages 5 for supplying combustion air to the cylinders of an internal combustion engine are formed. Shown is in FIG. 1 a first plastic housing part 2 that forms the lower central shell of an intake module in which the intake passages 5 extend. On the exterior side, approximately at the center of the plastic housing part 2, a support pin 3 is integrally formed that projects past the exterior side. The support pin 3 is surrounded by an annular support projection 4 that is also integrally formed on the wall of the housing. This support projection 4 projects slightly past the exterior surface of the first plastic housing part 2. The housing part 2 has a circumferentially extending flange-like rim area 6 by means of which the housing part 2 is connected, in particular by friction welding, to a further plastic housing part 7 that is positioned on top and forms the top central shell of the intake module. The intake passages 5 are delimited by the housing parts 2 and 7.

The support pin 3 on the exterior side of the first plastic housing part 2 enables an additional support of this housing part on a further vehicle component. In this way, the securing and supporting forces that act on or are exerted by the intake device 1 are uniformly distributed; this leads to a reduced local loading of the housing walls comprised of plastic material.

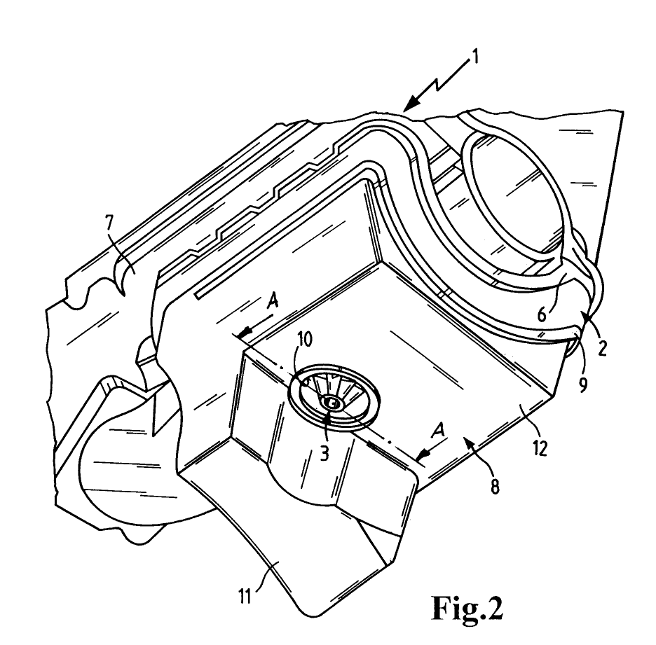

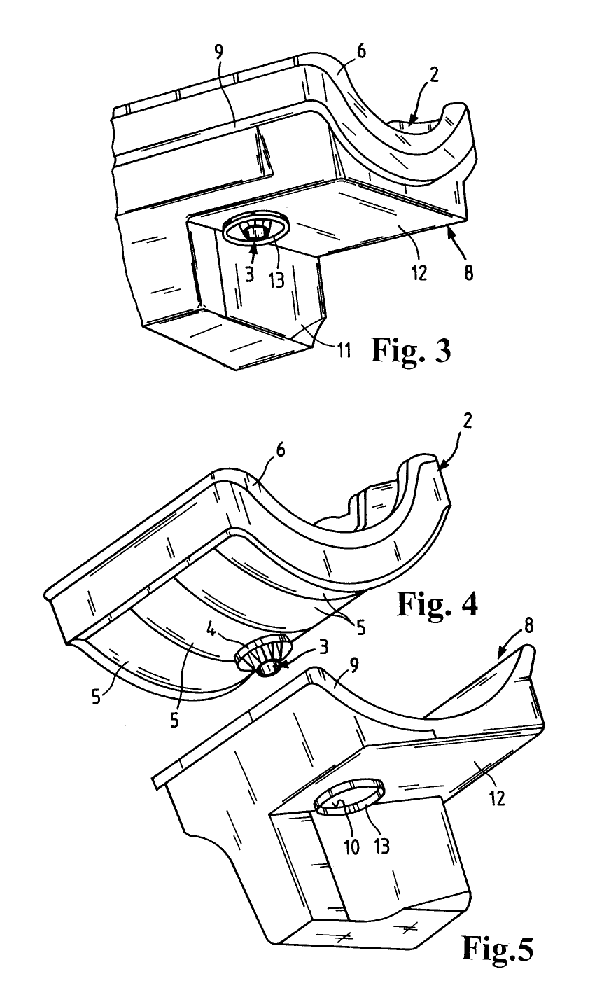

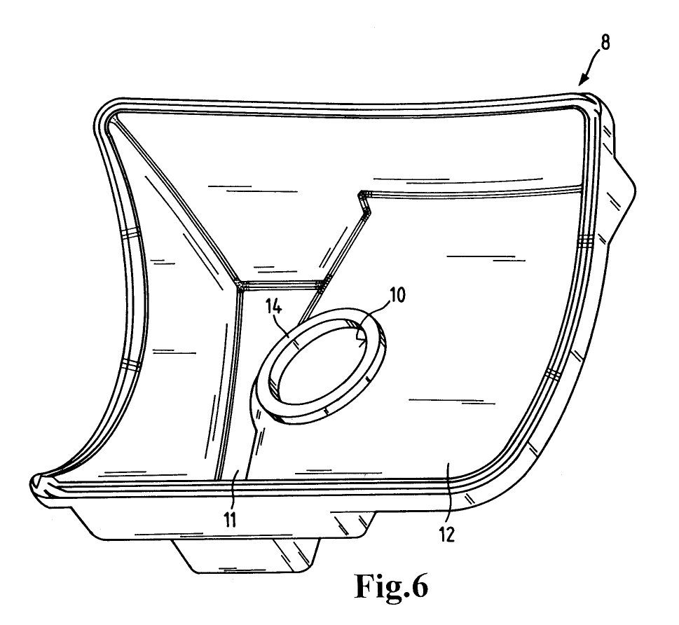

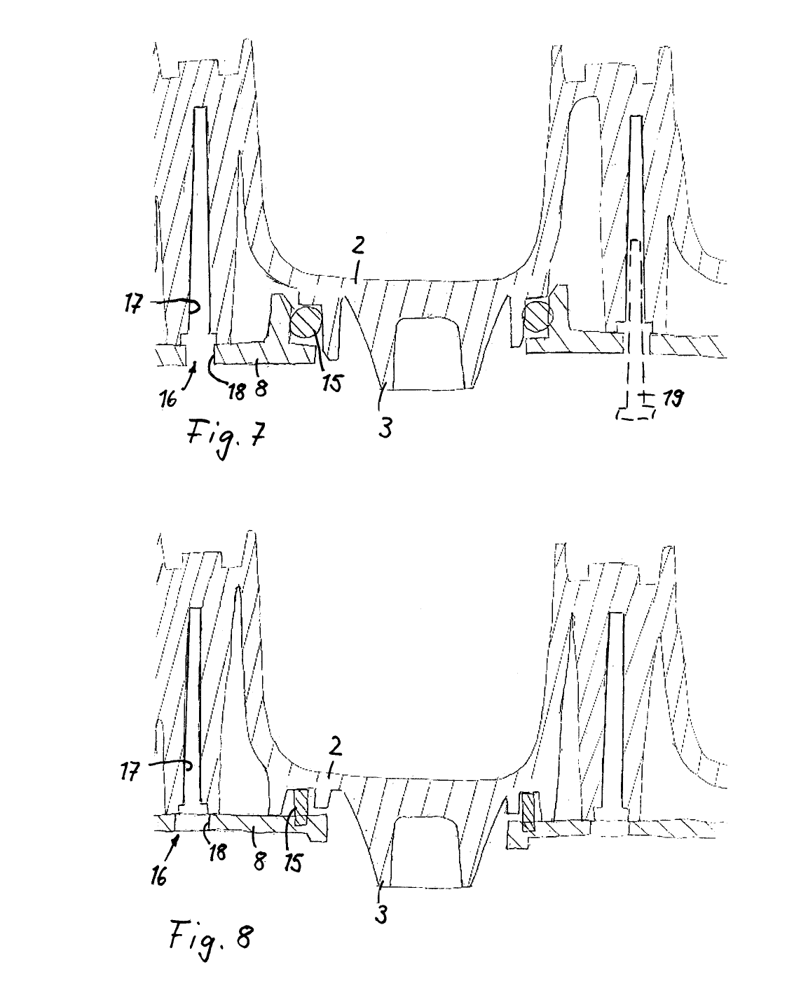

In FIG. 2 the intake device 1 is shown with an additional plastic housing part 8 that forms a vacuum storage device. The vacuum storage device is part of a vacuum adjuster for adjusting flaps in the intake passages wherein the flaps are secured on an adjusting shaft. The plastic housing part 8 is flanged to the exterior side of the first plastic housing part 2 and is in particular friction-welded by means of the circumferentially extending rim shoulder 9 that is a component of the housing part 8 to the first plastic housing part. Expediently, both housing parts 2 and 8 have substantially the same base surface so that the first plastic housing part 2 is completely engaged by the second housing part 8.

In the second plastic housing part 8 a cutout 10 is provided that corresponds to the support pin 3 on the first plastic housing part 2. In the mounted position according to FIG. 2, the support pin 3 extends through the cutout 10 and projects also past the exterior side of the second plastic housing part 8.

The second plastic housing part 8 which is embodied as a vacuum storage device is of a two-part configuration and comprises a deep storage section 11 and an adjoining fluidically connected shallow storage section 12. The cutout 10 is provided in the shallow storage section 12 in immediate vicinity to a wall that delimits the deep storage section 11.

As shown in the following FIGS. 3 to 5, the cutout 10 in the second plastic housing part 8 is surrounded by an annular projection 13 that projects past the surface of the shallow storage section 12. It can be expedient to match the height of this projection to the support pin 3 projecting through the cutout 10 so that the end face of the support pin and the end face of the projection 13 are at the same level which has the result that the two components together can be supported on a third component so that the supporting forces act on the first plastic housing part 2 as well as the second plastic housing part 8.

In FIG. 6, the interior of the second housing part 8 embodied as a vacuum storage device is illustrated. As can be seen, the cutout 10 is surrounded by a support shoulder 14 that is formed integrally on the inner side of the plastic housing part 8. This support shoulder 14 serves in the mounted state as a support for the corresponding support projection 4 on the exterior side of the first plastic housing part 2 (FIG. 4); the support surface 14 and the support projection 4 in this embodiment can form welding surfaces by means of which the two components are friction-welded.

Expediently, all plastic parts of the intake device are produced by injection molding.

FIG. 7 shows a section view according to section line A-A of FIG. 2 through the intake device 1 including the plastic housing part 8 that is a component of the vacuum storage. For pressure-tight sealing between the housing parts 2 and 8 a sealing element 15 that is embodied as a sealing ring is arranged between the housing parts wherein the sealing ring 15 is placed about the support pin 3. For radial and axial support action on the housing parts 2 and 8 mirror-symmetrically arranged angled projections are formed which together provide a receiving space for insertion of the sealing ring 15. In this way, the sealing ring 15 can transmit sealing forces in the axial direction as well as the radial direction.

The plastic housing parts 2 and 8 are connected by a bolt device 16 with one another. The bolt device 16 comprises a bolt 19 that is to be introduced into a receptacle 17 in the housing part 2 that is matched to the bolt and tapers slightly conically as well as into a bore 18 of the housing part 8 that is aligned with the receptacle 17. The bolt device 16 has a greater radial spacing relative to the support pin 3 than the sealing ring 15.

In the embodiment according to FIG. 8 the connection between the plastic housing parts 2 and 8 is also realized by means of a bolt device 16 that is constructively identical to that of FIG. 7. A difference resides in the embodiment of the sealing action between the housing parts 2 and 8 because according to FIG. 8 the sealing element 15 is embodied as an axially acting sealing element that transmits sealing forces in the axial direction. It is also embodied as a sealing ring that is placed about the support pin 3 but the sealing element 15 has a rectangular cross-section while the sealing element in the embodiment according to FIG. 7 has a round cross-section. Moreover, in FIG. 8 the sealing element 15 is inserted into an annular groove on the first plastic housing part 2 that is delimited by two radially spaced apart walls of the housing part 2 and that is open on the side that is facing the housing part 8.

As an alternative to the bolt connection in the embodiments according to FIGS. 7 and 8 also a screw connection or a snap-on connection between the housing parts 2 and 8 is feasible.

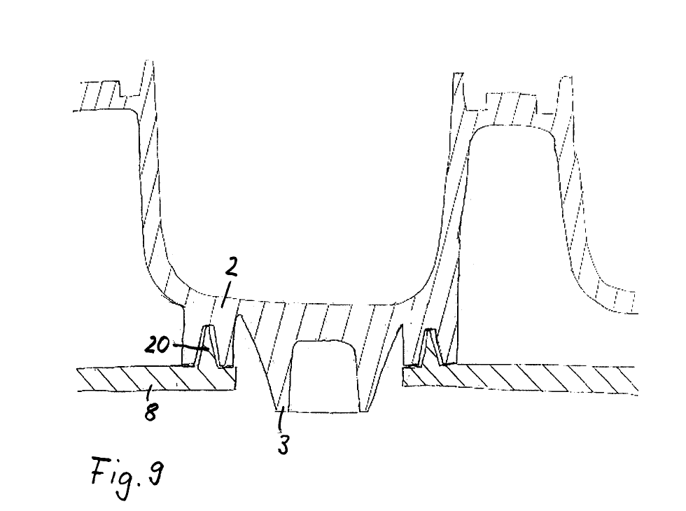

In the embodiment according to FIG. 9 the housing parts 2 and 8 are glued together which has the advantage that in addition to the force-transmitting connection also a pressure-tight connection between the housing parts is realized so that an additional sealing element is basically not required. The connection is realized in such a way that a projection 20 of triangular cross-section that is provided at the second housing part 8 and annularly surrounds the support pin 3 positive-lockingly engages a complementary annular groove on the first housing part 2. When the projection 20 or the annular groove are provided with glue, a fixed and pressure-tight connection is realized in the axial direction as well as radial direction.

1. An intake device for an internal combustion engine comprising at least two plastic housing parts (2, 8) resting against one another, characterized in that on the first plastic housing part (2) a support pin (3) is arranged that passes through a corresponding cutout (10) in the second housing part (8).

2. The intake device according to claim 1, characterized in that the support pin (3) arranged on the first plastic housing part (2) has a support projection (4) that rests against a corresponding support shoulder (14) that delimits the cutout (10) in the second plastic housing part (8).

3. The intake device according to claim 1 or 2, characterized in that the two plastic housing parts (2, 8) are welded to one another, in particular by friction welding.

4. The intake device according to claim 2 or 3, characterized in that the two plastic housing parts (2, 8) are welded together along their circumference and along the support shoulder (14) delimiting the cutout (10).

5. The intake device according to one of the claims 1 to 4, characterized in that the second plastic housing part (8) in which the cutout (10) for the support pin (3) is provided forms a vacuum storage device.

6. The intake device according to claim 5, characterized in that the vacuum storage device has two storage sections (11, 12) of different depth wherein in the shallower storage sections (12) the cutout (10) for the support pin (3) is provided.

7. The intake device according to one of the claims 1 to 6, characterized in that the exterior side of the first plastic housing part (2) is completely engaged by the second plastic housing part (8).

8. The intake device according to one of the claims 1 to 7, characterized in that between the first plastic housing part (2) and the second plastic housing part (8) a sealing element (15) is arranged that is arranged adjacent to the support pin (3).

9. The intake device according to one of the claims 1 to 8, characterized in that the first plastic housing part (2) and the second plastic housing part (8) are glued together.

10. The intake device according to one of the claims 1 to 9, characterized in that the first plastic housing part (2) and the second plastic housing part (8) are connected to one another by a bolt device (16).
